(19) United States
(12) Patent Application Publication
(10) Pub. No.: US 2014/0353928 A1
(43) Pub. Date: Dec. 4, 2014

(54) SELF-ADHESIVE MECHANICAL SEAL WITHOUT A REMOVABLE RELEASE LAYER

(71) Applicant: Steven R. Nethery, South Beloit, IL (US)

(72) Inventors: Steven R. Nethery, South Beloit, IL (US); Jack R. Nethery, Rockford, IL (US)

(73) Assignee: Steven R. Nethery, South Beloit, IL (US)

(21) Appl. No.: 14/288,845

(22) Filed: May 28, 2014

Related U.S. Application Data
(60) Provisional application No. 61/828,308, filed on May 29, 2013.

(51) Int. Cl. F16J 15/02

(52) U.S. Cl. CPC F16J 15/022
USPC 277/630; 156/278

(57) ABSTRACT

One embodiment of the invention comprises a self-stick weather stripping, seal or other gasket structure which does not utilize a separate removable release layer. In some embodiments, a fibrous material or open or closed cell foam core material will be surmounted by a polyethylene (of a variety of different densities), vinyl, polypropylene, nylon, polyester or other conformable skin backing which has been permanently affixed to the core layer. An embodiment of the upper surface of the backing will be coated with a material such as silicone or any other low surface energy material which functions as a release coating when the adhesive surface of the core material is pressed against it. By permanently bonding the upper surface to the core/base material it now becomes a permanent component of the core/base material.

### CROSS REFERENCE TO RELATED APPLICATION

This application claims the benefit of U.S. Provisional Application No. 61/828,308 filed May 29, 2013, and is incorporated by reference in its entirety for all purposes.

### FIELD OF THE INVENTION

The present invention relates generally to the field of gaskets and seals and, more particularly, the field of nonmetallic manufactured products that are manufactured and shipped with various types of pressure sensitive adhesives.

### BACKGROUND OF THE INVENTION

Premanufactured weather stripping, seals, gaskets, and other mechanical seals may be held in place and/or applied to its final installation location via the use of pressure sensitive adhesives. According to such practices at least one side of a portion of a mechanical seal such as weather stripping and, more particularly, such as foam or fibrous weather stripping, typically has a pressure sensitive adhesive applied during its manufacture. A cover is then applied to the mechanical seal to prevent its adhesive layer from becoming contaminated or stuck to surfaces before it is used. This cover, or release layer, is normally quite slick in order for it to be able to be placed into direct contact with the adhesive and yet be easily removed at time of installation without damage to either the core/base layer or the release layer and leaving the adhesive on the core layer substantially intact. Absent this sort of arrangement, transport of any substantial quantity of such to a job site would become problematic.

However, at the job site when sections of the release layer are removed during installation and dropped or otherwise accumulate on walking surfaces, they can become a hazard. Further, the above process generates a great deal of waste as the release strips are not normally reused but are instead thrown away. Also, removing the separate release layer can be very difficult and time consuming when done on the job.

As is well known in the sealing arts, there has been a need for a system and method that provides a better way to transport foam and other sorts of gaskets or mechanical seals that have a pressure sensitive adhesive system pre-applied thereto which do not utilize a separate removable release layer. Accordingly, it should now be recognized, as was recognized by the present inventors, that there exists, and has existed for some time, a very real need for a product and a method manufacturing same that would address and solve the above-described problems.

Before proceeding to a description of the present invention, however, it should be noted and remembered that the description of the invention which follows, together with the accompanying drawings, should not be construed as limiting the invention to the examples (or embodiments) shown and described. This is so because those skilled in the art to which the invention pertains will be able to devise other forms of this invention within the ambit of the appended claims.

### SUMMARY OF THE INVENTION

Other embodiments and variations are certainly possible within the scope of the instant invention and can readily be formulated by those of ordinary skill in the art based on the disclosure herein.

The invention of the present disclosure, in one aspect thereof, comprises a self-stick weather stripping or other nonmetallic gasket/mechanical sealing structure which does not utilize a separate removable release layer. The materials that are used to make the mechanical sealing structure (i.e., the core or base layer) will typically vary depending upon the intended usage, e.g., sealing out water, sound or any other foreign object, etc. In some embodiments, a compressible and flexible fibrous material or open or closed cell foam core material will be surmounted by polyethylene (including polyethylene of any of a variety of different densities), vinyl, polypropylene, nylon, polyester or a similarly high conformable release skin backing which has been permanently affixed to the base layer by a method of attachment of the sort well known to those of ordinary skill in the art (e.g., hot forced air, chemical solvent, 100% solid, emulsion, UV or Electron Beam adhesive systems, etc.). The upper or free surface of the backing will preferably be coated with a release material, such as silicone or other low surface energy material (e.g., fluoropolymers, raw polyethylene, and propylene) which function as a release coating when the bottom surface of the core material is pressed against it. This allows the base layer to be rolled into a cylindrical shape, stacked with one layer on top of the other, etc., without the use of a removable release layer.

The foregoing has outlined in broad terms the more important features of the invention disclosed herein so that the detailed description that follows may be more clearly understood, and so that the contribution of the instant inventors to the art may be better appreciated. The instant invention is not to be limited in its application to the details of the construction and to the arrangements of the components set forth in the following description or illustrated in the drawings. Rather, the invention is capable of other embodiments and of being practiced and carried out in various other ways not specifically enumerated herein. Finally, it should be understood that the phraseology and terminology employed herein are for the purpose of description and should not be regarded as limiting, unless the specification specifically so limits the invention.

### BRIEF DESCRIPTION OF THE DRAWINGS

Other objects and advantages of the invention will become apparent upon reading the following detailed description and upon reference to the drawings in which:

FIG. 1 is a side view of a roll of foam stripping with a traditional removable backing layer to covering an adhesive layer.

FIG. 2 is a side view of a section of foam stripping with a removable backing layer partially removed.

FIG. 3 is a side view of a roll of foam stripping according to the present disclosure that does not require the use of a removable backing layer.

FIG. 4 is a side view of a portion of foam stripping according to the present disclosure that does not require the use of a removable backing layer.

FIG. 5 is a stack of foam gaskets according to the present disclosure that do not require the use of a removable backing layer.

### DETAILED DESCRIPTION OF THE PREFERRED EMBODIMENTS

Before proceeding to a detailed description of various embodiments of the instant invention, it should be noted and remembered that other embodiments and variations are certainly possible within the scope of the instant invention and can readily be formulated by those of ordinary skill in the art based on the disclosure herein.

In various embodiments, the present disclosure provides for a self-stick weather strip, gasket, or other seal that does not require a separable release layer. Although some embodiments are described in terms of foam, sealing or other weather stripping products, other embodiments are suitable for, and used in connection with, gaskets, seals, insulating panels, and other applications which may require a polymeric cellular foam-type member to be adhered as a mechanical seal to a machine component or other surface.

Note that for purposes of the instant disclosure, the term “core layer” will be defined to include compressible and flexible materials that would be suitable for use as gasket, weather stripping, or other sort of seal. These are materials that would be suitable to receive a pre-applied pressure sensitive adhesive, as discussed below, and that be permanently attached to a backing member that can be imbued, coated, treated, etc., on its free surface with a release coating such as silicone. The sort of materials that might be suitable for a core layer would include, by way of specific examples only, foam (both open and closed foam), fibrous materials of different types (felt, etc.), rubber, etc.

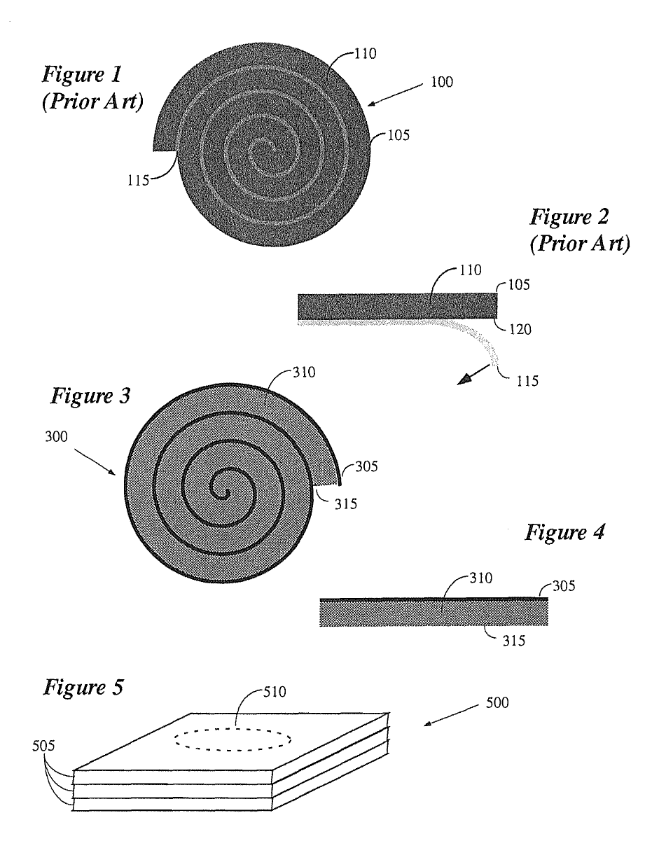

Referring first to the examples set out in FIGS. 1 and 2, in these figures prior art versions of a self-stick core layer such as weather stripping are illustrated. FIG. 1 illustrates a configuration by which conventional weather stripping 100 might be shipped to an end user. As should be clear from that figure, the weather stripping 110 may be shipped as a coil with successive layers of the weather stripping being separated by a removable release layer 115. As is indicated in FIG. 2, the release layer 115 is designed to be separated/removed by the end user from the underside of the weather stripping 110 and discarded at the point of installation. Underneath the removable release layer 115 may be a pressure sensitive adhesive 120 that is applied to the lower surface of the foam layer 110. This adhesive layer 120 will normally be applied at the time of manufacture or packaging of the coil 100. Absent the removable release layer 115 the coiled weather stripping 110 could not be stored in this sort of configuration since the pressure sensitive adhesive 120 would cause each layer to stick to the layer beneath it.

Conventionally, the removable release layer 115 will be comprised of a material that does not adhere strongly to the adhesive layer 120, although it typically requires at least some amount of adhesion to keep it in place during manufacture, transportation, and subsequent application. More particularly, it may have a relatively slick surface such that a required degree of adhesion is formed between the liner 115 and adhesive 120 to allow for shipping and handling of the coil, but wherein removal of the liner 115 will not substantially damage or otherwise impair the subsequent use of the adhesive for installation of the foam or other type material on the job site. Note also that absent the liner 115, the coiled configuration as is illustrated in FIG. 1 would not be workable since the adhesive 120 would then have direct contact with the top 105 of the surface layer 110 of the coil below. In some embodiments, the surface layer 110 might comprise polyethylene or another conformable product designed to add abrasion resistance to the typically soft open or closed cell foam material 110.

In another embodiment, the surface layer 110 is the same material throughout the thickness of the core material. The core material may be, for example, fibrous or open or closed cell foam materials. In any event, absent the removable release layer 115, the adhesive system 120 would adhere to the top of layer 110 and prevent the coil from unwinding when needed.

As noted above, the use of a removable release layer 115 creates a number of problems for the installer. For example, once the roll is unbound it may tend to completely unwind becoming twisted, tangled and dirty (e.g., if the roll is laid on a floor while it is being used). As stated previously, it takes additional time to start and remove the release layer 115 when installing the material 100. The removed release layer 115 may be slippery if left on the floor or other work surfaces, thereby becoming a safety hazard. The release layer will normally be treated as waste when removed; it must be collected later and disposed of Finally, from a manufacturing standpoint, use of a removable release layer 115 adds to the expense of the manufacture of the product 100.

Turning next to a detailed discussion of an embodiment of the instant invention as illustrated in FIG. 3, a weather stripping/sealing product without a removable release layer is shown according to the present disclosure. As is generally indicated in FIGS. 3 and 4, in an embodiment 300 a fibrous material (e.g., nonwoven or felt or open or closed cell foam core material) 310 core layer is surmounted by a polyethylene (of any number of different densities), vinyl, polypropylene, nylon, polyester or another conformable combination of aforesaid products or a similar highly comfortable backing 305 (e.g., of about 5-2.0 mils in thickness). In this embodiment, the backing 305 has been affixed to the foam layer 310 by a permanent adhesive system (e.g., hot forced air, solvent, 100% solid, emulsion, UV or Electron Beam adhesive systems, etc.). The upper skin surface of the backing 305 may be coated or otherwise imbued with a material such as silicone or some other low surface energy material (e.g., fluoropolymers, raw polyethylene, or propylene) to function as a release coating. Note that the low surface energy material, whether silicone or one of the other materials listed above, will need to be chosen with respect to the particular pressure sensitive adhesive employed. As is indicated below, using silicone as the low surface energy material tends to work well with adhesives such as a pressure sensitive acrylic or rubber based adhesive system.

According to some embodiments, the amount of silicone or other materials that are applied to the backing 305 will be determined by trial and error depending on the type of low surface energy material, the adhesive, the core/base material and the material from which the backing is made. Generally speaking, it is preferable to use as little silicone or other material as possible. As a specific example, some embodiments have utilized about 0.25 to 1.0 pounds of silicone per ream of backing material. Within that range, the exact amount of silicone to use may need to be determined by trial and error according to methods well within the capabilities of one of ordinary skill in the art. Of course, the example given above is intended to generally describe a single embodiment and the amount of silicone or other material that is applied could be much less or much greater than these exemplary values.

On a bottom surface of the foam member 310 (opposite the backing 305), a pressure sensitive adhesive 315 is applied. In specific application, the adhesive 315 is chosen such that it provides the degree of adhesion needed when installing the foam 310, yet is separable from the release/silicone-treated skin backing member 305. Another consideration is that the adhesive will need to adhere well enough to the treated backing layer 305 such that the functional adhesive is protected from contamination until it is removed from contact with the skin backing layer 305 commensurate with installation of the foam layer 310. The adhesive layer 315 may also aid in preventing the entire coil 300 from unrolling prior to use. In some preferred embodiments, a pressure sensitive acrylic or rubber based adhesive system (e.g., 2-EHA, BA, or SBR) is used, depending upon the final function desired.

The bottom surface of the core material 310 having the adhesive layer 315 may be pressed against backing 305 when coils 300 are formed. When used in this configuration, the adhesive 315 will not permanently adhere to the upper surface of the skin backing member 305 by virtue of the coating that has been placed thereon. Thus, a roll of weather stripping 300 can be manufactured that does not require a separate removable release layer or other material to be affixed to the adhesive surface while maintaining the conformability of the core material.

Referring now to FIG. 5 an additional embodiment according to the present disclosure is shown. In the example of this figure a stack 500 of foam gaskets 505 is illustrated that does not require the use of a separate removable backing layer between each gasket 505. In the stack 500, the lower surface of the layer 505 will be coated with a pressure sensitive adhesive of the sort discussed. Similarly, the upper skin surface of each layer 505 will be covered with a polyethylene of an appropriate density, vinyl, polypropylene, nylon, polyester or any combination of afore said products or a similar conformable backing layer or other backing material that has been coated with silicone or another low surface energy material, thereby making it easy to separate layers 505 from each other. It will be appreciated that the individual gaskets 505 can be manufactured with relatively complex shapes as may be needed for some applications. For example, the material may be perforated or die cut in such a way that removal of the material 510 can be used to create a gasket with a hole or other features therein.

It will also be appreciated that the exact configuration of the foam or fibrous products may vary from those examples shown herein. Weather stripping, sealing and gasket applications have been described with some specificity but it will be appreciated that the disclosed system of a core layer sandwiched between a pressure sensitive adhesive and an affixed backing release layer is applicable to a wide array of product configurations.

Additionally, for simplicity, the center/core layer has been shown in the various embodiments as substantially homogenous foam (e.g., open or closed cell). However, this need not be the case in every application. In fact, the composition of the core layer may be heterogeneous with many sublayers that might be needed to provide the functionality is required of the core layer. Various meshes or other structurally enhancing features may also be embedded in the core layer. Similarly, the backing layer may have or contain various sub layers or materials that do not impede its ability to satisfactorily release from the adhesive layer as described. Further, although foam is suitable for many applications the instant invention could readily be applied to felt, fiber, etc., mechanical seals as well.

Note that for purposes of the instant application, the term “gasket” should be broadly construed to include the weather strip example described herein as well as any other nonmetallic material used to create a mechanical seal of the junction between two surfaces or, more generally, material that is used to prevent the movement of air, water, sound, etc. into or out of an enclosed area, where one surface of the material contains a pressure sensitive adhesive (e.g., a pressure sensitive acrylic or rubber based adhesive system such as 2-EHA, BA, or SBR) thereon and the other surface contains backing member which has been coated, imbued, infused, etc., with an amount of silicone or other low surface energy material sufficient to allow it to be placed into contact with the adhesive surface (e.g., in a roll or stack) and then readily separated from it, leaving both surfaces undamaged.

Finally, although the instant invention has been generally described as being applied to a foam gasket or other sealing material, the same or a similar technology could be applied to other cellular material (e.g., fiber, felt, etc.) to eliminate the need for a release layer.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

While this invention is susceptible of embodiment in many different forms, there is shown in the drawings, and is herein described in detail, some specific embodiments. It should be understood, however, that the present disclosure is to be considered an exemplification of the principles of the invention and is not intended to limit it to the specific embodiments or algorithms so described. Those of ordinary skill in the art will be able to make various changes and further modifications, apart from those shown or suggested herein, without departing from the spirit of the inventive concept, the scope of which is to be determined by the following claims.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art.

What is claimed is:

1. A self-adhesive mechanical seal, comprising:
(a) a core layer having an upper surface and a lower surface treated with a pressure sensitive adhesive; and,
(b) a flexible backing layer permanently affixed to said upper surface of said core layer, said backing layer having been treated with a low surface energy material sufficient to allow said pressure sensitive adhesive of said core layer to be brought into contact with said treated backing layer and removed without damaging either said core layer or said backing layer and leaving the pressure sensitive adhesive on said lower surface of said core layer substantially intact.

2. The self-adhesive mechanical seal according to claim 1, wherein said low surface energy material is selected from a group consisting of silicone, a fluoropolymer, a raw polyethylene, and propylene.

3. The self-adhesive mechanical seal according to claim 1, wherein said core layer is selected from the group consisting of an open cell foam, a closed cell foam, a fibrous material, a felt material, and a rubber material.

4. The self-adhesive mechanical seal according to claim 1, wherein said core layer is compressible and flexible.

5. The self-adhesive mechanical seal according to claim 1, wherein said backing layer is permanently affixed to said upper surface of said core layer by hot forced air, a chemical solvent, an adhesive, an emulsion, a UV or Electron Beam adhesive systems.

6. The self-adhesive mechanical seal according to claim 1, wherein said mechanical seal is stored in a rolled configuration with said lower surface of said core layer in contact with said upper surface of said flexible backing layer.

7. The self-adhesive mechanical seal according to claim 1, wherein there are a plurality of said self-adhesive mechanical seals and wherein said plurality of self-adhesive mechanical seals are stacked together, with a flexible backing layer of one of said at mechanical seals being placed into direct contact with a pressure sensitive adhesive of another of said at least one mechanical seals.

8. The self-adhesive mechanical seal according to claim 1, wherein said low surface energy material is silicone and said backing layer is treated with between about 0.25 and 1.0 pounds of silicone per ream of backing layer.

9. A self-adhesive gasket, comprising:
(a) a core layer having an upper surface and a lower surface with a pressure sensitive adhesive applied thereto; and,
(b) a flexible backing layer having an upper surface and a lower surface, wherein
(1) said lower surface of said backing layer is permanently affixed to said upper surface of said core layer, and,
(2) said upper surface of said backing layer has a low surface energy material applied thereto in a quantity sufficient to permit said pressure sensitive adhesive on said core lower surface to be pressed against said flexible backing upper layer and removed without damaging either said core layer or said backing layer and leaving said pressure sensitive adhesive on said lower surface of said core layer substantially intact.

10. The self-adhesive mechanical seal according to claim 9, wherein said low surface energy material is selected from a group consisting of silicone, a fluoropolymer, a raw polyethylene, and propylene.

11. The self-adhesive mechanical seal according to claim 9, wherein said core layer is selected from the group consisting of an open cell foam, a closed cell foam, a fibrous material, a felt material, and a rubber material.

12. The self-adhesive mechanical seal according to claim 9, wherein said core layer is compressible and flexible.

13. The self-adhesive mechanical seal according to claim 9, wherein said backing layer is permanently affixed to said upper surface of said core layer by hot forced air, a chemical solvent, an adhesive, an emulsion, a UV or Electron Beam adhesive systems.

14. The self-adhesive mechanical seal according to claim 9, wherein said self-adhesive gasket is stored in a rolled configuration with said lower surface of said core layer in contact with said upper surface of said backing layer.

15. The self-adhesive mechanical seal according to claim 9, wherein there are a plurality of said self-adhesive gaskets and wherein said plurality of self-adhesive gaskets are stacked together with a flexible backing layer of one of said at mechanical seals in contact with a pressure sensitive adhesive of another of said at least one self-adhesive gaskets.

16. The self-adhesive mechanical seal according to claim 9, wherein said low surface energy material is silicone and said backing layer is treated with between about 0.25 and 1.0 pounds of silicone per ream of backing layer.

17. A method of constructing a self-adhesive mechanical seal, comprising the steps of:
(a) obtaining a core layer;
(b) applying a pressure sensitive adhesive to a lower surface of said core layer;
(c) permanently affixing a flexible backing layer to an upper surface of said core layer; and
(d) coating said flexible backing layer with between about 0.25 and 1.0 pounds of silicone per ream of said backing layer.
